(19) United States
(12) Patent Application Publication
(10) Pub. No.: US 2008/0243289 A1
(43) Pub. Date: Oct. 2, 2008

(54) Model maintenance architecture for advanced process control

(75) Inventors: Ramprasad Yelchuru, Bangalore (IN); Harigopal Raghavan, Bangalore (IN); Ravindra D. Gudi, Bangalore (IN); Jagadeesh Brahmajosyula, Krishnanagar (IN); Srinivasa Prabhu Edamadaka, Bangalore (IN)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/729,058

(22) Filed: Mar. 28, 2007

(51) Int. Cl. G06F 19/00

(52) U.S. Cl. 700/109

(57) ABSTRACT

A system and method modifies a dynamic model of a process in a plant for an advanced process control controller wherein the model includes sub models. Performance of the controller is monitored and performance degradation is quantified as the process changes. It is then determined whether a selected number of sub models need updating or the entire model dynamics need updating as a function of the quantified controller performance degradation If a selected number of sub models need updating, an excitation signal is initiated for such sub models to identify new sub models. If the entire model dynamics need updating, a complete perturbation signal is initiated and triggers exhaustive closed-loop identification of entire model. The newly identified model or sub models is incorporated in the controller.

### BACKGROUND

For competitive manufacturing, reducing the operating costs, maintaining high productivity and consistent quality are vital for the profitability of the industry. Installations of advanced process control (APC) strategies have shown to increase the profits and provide the above quality requirement. However, the performance of these control strategies is observed to degrade over time. This performance degradation is attributed to inadequate monitoring of closed loop performance and initiation of maintenance/enhancement of the quality of the individual entities such as process models.

APC controllers are implemented in refineries and chemical plants worldwide for major processing units. Maneuvering from present operating regimes to more profitable and productive regimes is feasible with a multivariable APC strategy. Various operating and design constraints related to the process can be easily accommodated in the control law formulation.

The quality of process control models used in APC plays a vital role in its performance. In a typical APC project, these models are identified during the installation of APC project using uni-variate step testing. However, chemical processes are inherently nonlinear in nature and also involve time varying parameters such as activity of catalysts; hence, minor changes in process parameters (i.e. scaling in heat exchangers, feed quality change, throughput rate changes, wear and tear of valves, sensors) can result in significant changes in the process dynamics. Usage of the same models in APC (without concern for these time varying characteristics) degrades the overall control performance and forces the operators to switch the controllers off.

In the absence of high fidelity models, aggressive controller designs cannot be realized. The closed loop control performance will be constrained by considerations related to stability and robustness. Specification requirements on the plant outputs and targets on the inferred variables will not be aggressively met, thus substantially reducing the benefits of deploying the advanced control algorithms. Accurate identification of system dynamics is therefore a continuing task that cannot stop after the initial step; the model fidelity needs to be continuously monitored and maintained to reap the benefits of advanced control.

### SUMMARY

An architecture is provided that performs both monitoring and maintenance tasks for APC. Performance degradation attributable to inadequate monitoring and maintenance is minimized by use of the architecture.

### BRIEF DESCRIPTION OF THE DRAWINGS

FIG. 1 is a block diagram of an architecture for model maintenance in advanced process control controllers according to an example embodiment.

FIG. 2 is an illustration of a process having multiple operating PIDs and an advanced process control controller according to an example embodiment.

FIG. 3 is a flowchart of a method that may be used to update models for an APC controller in one embodiment.

FIG. 3 is a flowchart of a method that may be used to update models for an APC controller in one embodiment.

FIG. 3 is a block diagram of an example computer system for executing methods according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of storage devices. The term “computer readable media” is also used to represent any means by which the computer readable instructions may be received by the computer, such as by different forms of wireless transmissions. Further, such functions correspond to modules, which are software, hardware, firmware or any combination thereof. Multiple functions are performed in one or more modules as desired, and the embodiments described are merely examples. The software may be executed on a digital signal processor, ASIC, microprocessor, or other type of processor operating on a computer system, such as a personal computer, server or other computer system.

Chemical processes are inherently nonlinear in nature. Minor changes in process related parameters (E.g.: catalytic reactivity, feed composition change, changes in operating condition, throughput, etc) also result in significant changes in process dynamics. These changes in the process dynamics might make the predictions realized by the models that are used in APC, to become inaccurate. This leads to switching the APC off, resulting in less APC online usage time.

A system and method modifies a dynamic model of a process in a plant for an advanced process control controller wherein the model includes sub models. Performance of the controller is monitored and performance degradation is quantified as the process changes. It is then determined whether a selected number of sub models need updating or the entire model dynamics need updating as a function of the quantified controller performance degradation If a selected number of sub models need updating, an excitation signal is initiated for such sub models to identify new sub models. If the entire model dynamics need updating, a complete perturbation signal is initiated and triggers exhaustive closed-loop identification of entire model. The newly identified model or sub models are incorporated in the controller.

In one embodiment, a method of modifying a dynamic model includes the following elements:
1) Obtain desired performance requirements of the controller from the steady state optimization of the process, which is driven by the market needs.
2) Evaluate the present performance of the controller and quantify the performance degradation as the process changes over time.
3) If the performance of controller degrades beyond a threshold, this is attributable to lower fidelity of either (i) some components or (ii) all of the components of the dynamic model. Accordingly, check whether only a small subset of the model(s) dynamics needs to be updated or whether all the model dynamics need to be updated. This threshold is obtained from a priori knowledge of the process.
4) If sub model(s) dynamics have changed, initiate input (excitation) signal design for this smaller set of variables pertaining only to those subset of models and perform closed-loop identification/updating for these sub model(s) alone.
5) If all sub models need to be updated, and then initiate a complete perturbation signal design and trigger the exhaustive closed-loop identification.
6) Incorporate the newly identified models in the APC algorithms to achieve improved closed loop performance.

Installation of APC aids in running process units at a desired operating point to increase the profitability of plant. But the APC performance is observed to degrade over time due to inadequate monitoring and maintenance. This degradation in the performance of APC leads to poor quality products and directly affects the profits. The system and methods described may perform the necessary tasks to regain and sustain the profits accrued by APC. Thus it will add value to the business.

Increasing the APC effective online usage time for any process control system aids in operating the process at more profitable and productive regimes. Models used in APC control strategy play a vital role in its performance. APC performance is shown to degrade over time due to changes in process parameters as scaling of heat exchangers, feed quality changes, throughput rate, operating conditions. At times these process changes could even lead to switching the APC off, resulting in less usage time. Various embodiments of the present invention perform process monitoring and model maintenance tasks for APC. This allows the model for a controller to be changed quickly when degradation occurs and can result in increased throughput for a process, such as an industrial process. The methodology is generic in nature and may easily be customized for model maintenance in any model based control strategy.

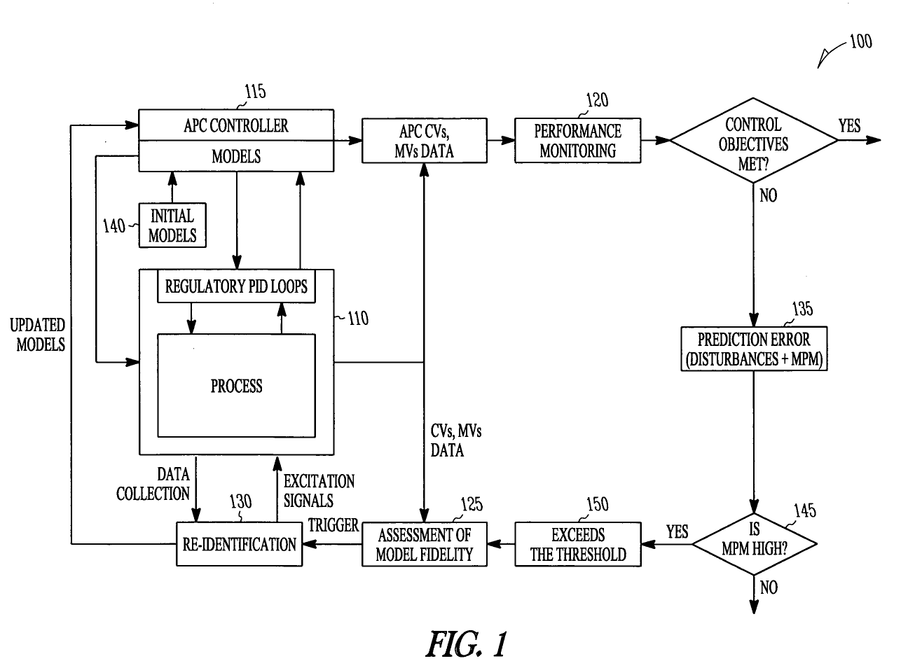

FIG. 1 is a functional block diagram of an architecture 100 for performing model maintenance in advanced process control products. Architecture 100 includes five blocks or tasks, namely Process+Regulatory PID (Proportional Integral Derivative) loops 110, APC controller 115, Performance monitoring tools 120, Model fidelity assessment 125 and Re-identification steps 130. These tasks are performed in a logical manner to perform the model maintenance task. This gives an integrated framework to ensure deployment of high-fidelity models in a systematic way.

Effective online usage time of the APC tool is a major indicator of performance of Advanced Process Control (APC). As these model-based controllers have a significant impact on the control and optimization of industrial processes, increasing the APC online usage time directly aids in increasing profits. The quality of models affects the profits through the tasks of optimization for set-points and design of the control actions to realize these set-points.

Process+Regulatory PID loops 110: This block constitutes the operating process and regulatory level PID loops working on the process of concern. In this disclosure, it is assumed that events such as sensor/actuator faults, leaks in pipelines are systematically addressed by other commercial packages and are therefore not considered here.

In general, PID controllers are monitored while the process is running at an operating point. There are various commercially available monitoring tools to monitor the health of the regulatory PID loops. One among such products is Honeywell's Loop Scout. During such monitoring, there may be sensor or/and actuator faults. These should be tackled at the device level using smart devices. Process abnormalities, for example process faults like leaks can be identified using for example Asset Manager PKS from Honeywell International, Inc., which uses the results obtained from the Abnormal Situation Management (ASM) Consortium's research. Even in situations where diagnostic capability does not exist at the device level for sensor and actuator faults, it is more appropriate for these faults to be handled by the asset management tool in order to prevent duplication of job capabilities and responsibilities. By using above mentioned tools one may conclude that the regulatory PID loops performance on the process is satisfactory.

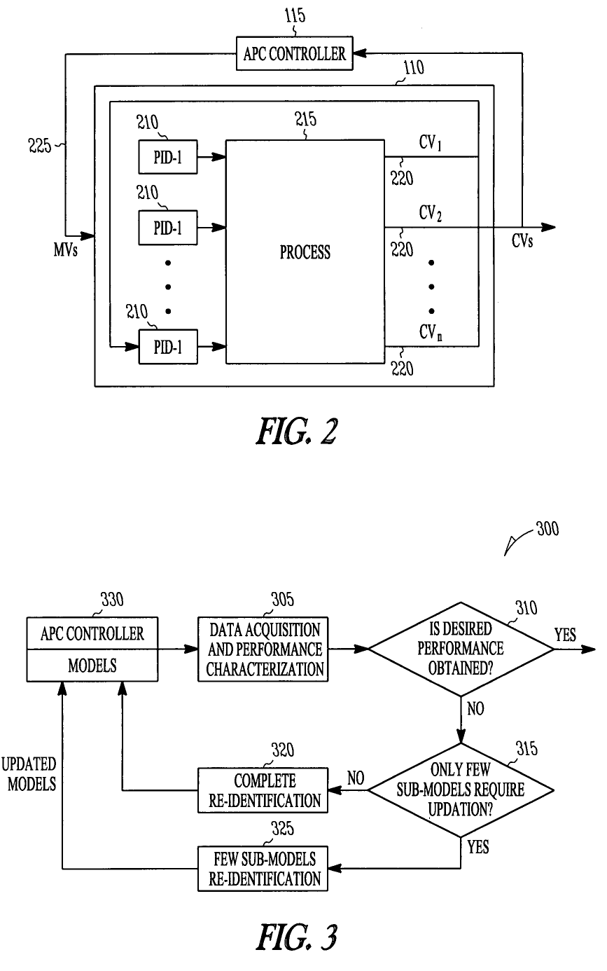

The data exchange in Process+Regulatory PID loops 110 is related to the exchange between PID blocks 210 and the actual process 215 in FIG. 2. Measured and regulated variables in the APC are called Controlled Variables (CV) 220 and the variables updated by the APC controller are called Manipulated Variables (MV) 225. The model 115 is the dynamic mathematical relationship between the MVs 225 and the CVs 220. A Prediction Error (PE) 135 in FIG. 1 is the difference between the measured values of the CVs the predictions of the CVs obtained via the dynamic process model.

APC controller 115: This block consists of two parts, namely models and controller action design using the models. The present architecture is generic in nature, and the control formulation may be customized to suit the control algorithm (i.e. DMCPlus (Dynamic Matrix Control Package), RMPCT (Robust Model Predictive Control Technology), HIECON (Hierarchical Constraint Control), PFC (Predictive Functional Control), SMOC (Shell Multivariable Optimizing Controller)) of interest. Data exchange to this block can be explained as: the inputs to this block are process CVs and the past MVs at APC level as indicated at block 140. The outputs from this block are the set points to regulatory PID loops 145.

Performance Monitoring 120: The task is related to the performance monitoring of the APC controller. Multivariable controller performance analysis, methods and challenges are well known to those of skill in the art. In one embodiment, a single index or metric by itself may not provide all the information required to diagnose the cause of poor performance. A few measures to perform the performance monitoring that may be used include poor product quality, increased variance of controlled variables over a specified window of samples, constraint violation, and degrees of Freedom at each sampling instant.

Poor product quality: Product quality is said to be poor, if the measured controlled variable values are away from their specified set points or ranges over a window size. The degree of degradation is quantified, based on how far the measurements are from their set points and ranges. The deviation of the CVs from set point and ranges at each sampling time is taken as a criterion. A threshold for this deviation can be specified as control limits (±standard deviation of CVs) or 95% confidence limits by the assumption that all the CVs follow normal distribution.

Increased variance over a window of samples: The window of samples is decided by the settling time of the controlled variable. Variance of measurements over a window with time gives an indication of the performance of the APC product. The window length is decided by the dominant settling time of the process of concern. This in turn affects the variance.

Constraint violation: In all the APC products, the free responses (i.e. the future responses of the CVs assuming no future changes in MVs) are predicted using the identified process models. An optimization problem is solved to arrive at the future MVs to drive the CVs to their respective set points or ranges. The optimization problem is bound by constraints that are incorporated in the problem formulation. Typically these constraints are absolute constraints, rate constraints on manipulated variables and constraints on controlled variable, besides other constraints related to operability of the process, process safety and environmental compliance.

If the future manipulated variable movements obtained after optimization lie within their constraints, it is said that there are no constraints violated. Otherwise, it is concluded that the constraints are violated. The number of constraints that are violated at each sampling instant may be observed and used for monitoring purposes.

Degrees of freedom: Basically the number of degrees of freedom is defined as the number of MVs that are not at a limit minus the number of CVs that either are at their set points or are outside a limit. The controller chooses MV values so as to minimize the number of CVs that are away from set point or outside limits.

Monitoring this value at each sampling instant will provide useful information if there are any disturbances affecting the process. The above mentioned issues are a few measures that can be used to quantify the controller performance or to quantify the degradation of the controller performance. If the contribution of the MPM 135 is higher in prediction error as indicated at 145, and exceeds a threshold at 150, the re-identification routine 130 is triggered.

Assessment of model fidelity 125: Often times, there is a possibility of a change in only one or two sub model dynamics, in a large MIMO (multi input multi output) system. In these cases, performing a total reidentification of the entire multivariable plant is an unnecessary wastage of both time and money. In one embodiment, a way of identifying which sub model dynamics in MIMO have changed is provided. Then the changed sub model(s) may be selected for reidentification. The controller tuning or formulation using the newly identified sub models can then be performed.

To detect such changes in the local sub-system dynamics, a general approach has been to use a regular spearman correlation index between the PEs and the MVs. This will highlight the un-modeled elements that contribute to reduced fidelity of the model. However, in large multivariate process controllers the manipulated variables are correlated among themselves. The presence of correlation among the manipulated variables makes the regular (spearman) correlation index an inappropriate criterion to decide on changes in the dynamics. In fact, use of this regular (spearman) correlation as a criterion in such a highly correlated scenario, could result in misleading conclusions. To overcome this drawback, a partial correlation analysis may be performed between the PEs and the MVs as criteria for deciding which or all of the sub-models have changed.

Re-identification 130: Re-identification is a very costly exercise and needs well planned experimentation to reduce both the identification testing time and cost. Amongst open loop and closed loop identification methods, the latter identification method may result in minimal perturbations in the plant and hence minimal loss in productivity during identification. Therefore, closed loop identification methods are used in one embodiment for re-identification.

Closed loop identification uses data pertaining to closed loop operation while the controller is active. While this approach preserves closed loop performance to some extent, the quality of data may not be good enough for re-identification. In addition, correlation between noise/disturbances and the manipulated variables degrade the quality of the identified model. Thus, in one embodiment, bias issues in the resulting model are addressed. In one embodiment, a plurality of the model state variables defining the model in terms of operational analysis are arbitrated to re-identify the model during active operation of the process

Having identified the sub-models that need re-identification, identification tests may be done to obtain information rich data for modeling. This identification exercise may include excitation signal design, model structure selection, parameter estimation and model validation. In identification tests, signal design is performed to ensure good signal to noise ratio(s) and minimal correlation among MVs, and MVs to disturbances. The model structure may be selected based on the apriori knowledge of process, and may be quite different for different processes. The parameters of the model with chosen model structure are estimated and the resulting models are validated for their adequacy of purpose on a fresh data set. Thus, the new models or sub model(s) are identified.

The models used in the APC controller models is updated with either the newly identified models from exhaustive re-identification or newly identified sub models. Smooth transition of models is desired and various methods are available as known to those of skill in the art. In one embodiment, an exponential transition between old models to the new models may be used. These newly identified models are used for predictions in the control formulation.

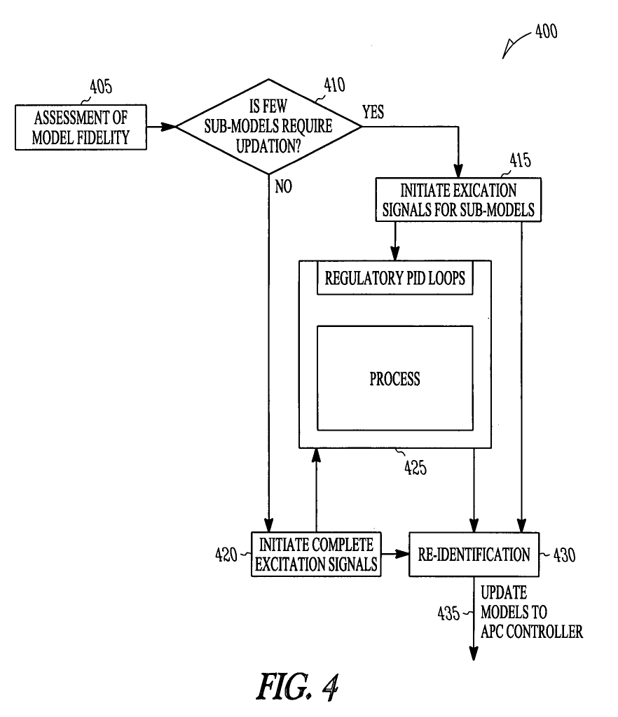

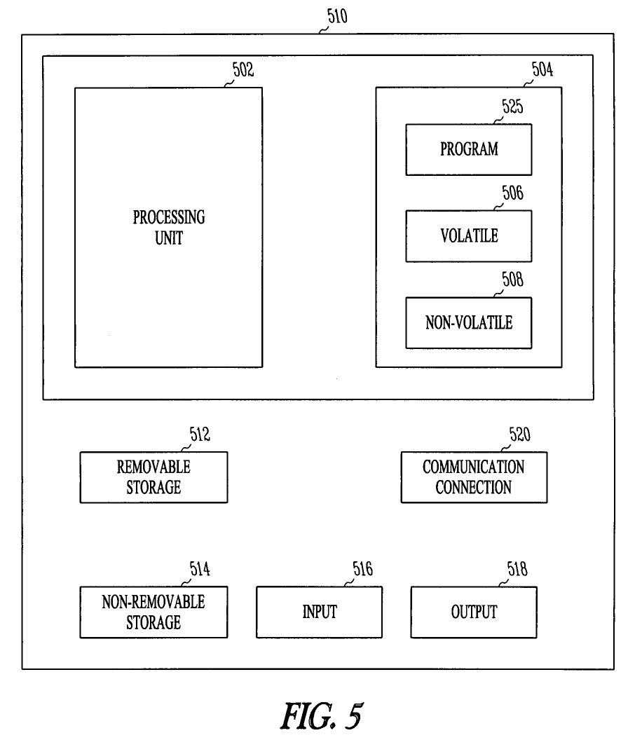

FIG. 3 is a flowchart of a method that may be used to update models for an APC controller in one embodiment. A method, for maintaining some or all of the sub-models used for advanced process control of a plant using a multivariate process controller is illustrated generally at 300. At 305, data is acquired and operating performance level of the process control is characterized. The data is analyzed at 310 to assess deviation of the operating performance level from the desired performance level of the process control. If desired performance is obtained, monitoring continues. At 315, the need for re-identification of the complete model or sub model of the multivariate process controller is assessed as a function of performance degradation. A plurality of the model state variables defining the model in terms of operational analysis thereof is arbitrated at to re-identify the model during active operation of the process. Closed loop re-identification of the models using the re-identified model for the process control is performed for either complete re-identification at 320 or re-identification of a selected number of sub models at 325. Models for the APC controller are then updated at 330.

In one embodiment, parameters contributing to the performance degradation includes parameters characterizing at least one of operational disturbances affecting the process or change of process performance target set point or a combination thereof. Re-identification may include at least one of developing a complete new model or a new sub model from online data. Arbitrating may include further arbitration of model state variables defining sub-models constructing the model. The prediction error may be estimated as a function of the degree of deviation of operating performance variables from target ranges over a data window.

In a further embodiment, the prediction error may be estimated as a function of the degree of variance over a time window based on settling time of the operating performance variables. A degree of differential contribution of model plant mismatch may be a function of assessment of violation of constraints on the process. The constraints may be selected from the group consisting of absolute constraints on the process, constraints on manipulative process variables, constraints on operating performance variables and combinations thereof. The degree of differential contribution of model plant mismatch may be a function of assessment of degree of freedom of the said constraint violation.

FIG. 4 is a flowchart of an alternative method that may be used to update models for an APC controller in one embodiment. A method of modifying a dynamic model of a process in a plant for an advanced process control controller wherein the model includes sub models is illustrated generally at 400. Model fidelity is assessed at 405. At 410, the method 400 determines whether a selected number of sub models need updating or the entire model dynamics need updating. If a selected number of sub models need updating, an excitation signal for such sub models is initiated at 415 to identify new sub models. If the entire model dynamics need updating, a complete perturbation signal is initiated at 420 and triggers exhaustive closed-loop identification of entire model. The signals are applied to the controller at 425, and re-identification occurs at 330. At 435, the newly identified model or sub models are incorporated in the controller.

A block diagram of a computer system that may execute programming for performing APC control and the algorithms involved in assessment and re-identification is shown in FIG. 5. As indicated above, alternative electronics, such as commercially available controllers and processors may also be used, and may share some characteristics of the computer system described below. A general computing device in the form of a computer 510, may include a processing unit 502, memory 504, removable storage 512, and non-removable storage 514. Memory 504 may include volatile memory 506 and non-volatile memory 508. Computer 510 may include—or have access to a computing environment that includes—a variety of computer-readable media, such as volatile memory 506 and non-volatile memory 508, removable storage 512 and non-removable storage 514. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 510 may include or have access to a computing environment that includes input 516, output 518, and a communication connection 520. The computer may operate in a networked environment using a communication connection to connect to one or more remote computers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 502 of the computer 510. A hard drive, CD-ROM, and RAM are some examples of articles including a computer-readable medium.

The Abstract is provided to comply with 37 C.F.R. § 1.72(b) to allow the reader to quickly ascertain the nature and gist of the technical disclosure. The Abstract is submitted with the understanding that it will not be used to interpret or limit the scope or meaning of the claims.

1. A method, for maintaining some or all of the sub-models used for advanced process control of a plant using a multivariate process controller, the method comprising:
acquiring data and characterizing operating performance level of the process control;
analyzing the said data to assess deviation of the operating performance level from the desired performance level of the process control;
assessing the need for re-identification of the complete model or sub model of the multivariate process controller as a function of performance degradation;
arbitrating a plurality of the model state variables defining the model in terms of operational analysis thereof to re-identify the model during active operation of the process; and
performing closed loop re-identification of the models using the re-identified model for the process control.

2. The method of claim 1, wherein parameters contributing to the performance degradation comprises parameters characterizing at least one of operational disturbances affecting the process or change of process performance target set point or a combination thereof.

3. The method of claim 1, wherein the said assessment of the need for re-identification is triggered as a function of a threshold defined from a priori knowledge of the operating process performance.

4. The method of claim 1, wherein re-identification comprises at least one of developing a complete new model or a new sub model from online data.

5. The method of claim 1, wherein arbitrating comprises further arbitration of model state variables defining sub-models constructing the model.

6. The method of claim 1, wherein the prediction error is estimated as a function of the degree of deviation of operating performance variables from target ranges over a data window.

7. The method of claim 1, wherein the prediction error is estimated as a function of the degree of variance over a time window based on settling time of the operating performance variables.

8. The method of claim 1, wherein a degree of differential contribution of model plant mismatch is a function of assessment of violation of constraints on the process.

9. The method of claim 8, wherein the constraints are selected from the group consisting of absolute constraints on the process, constraints on manipulative process variables, constraints on operating performance variables and combinations thereof.

10. The method of claim 1, wherein said degree of differential contribution of model plant mismatch is a function of assessment of degree of freedom of the said constraint violation.

11. A method of modifying a dynamic model of a process in a plant for an advanced process control (APC) controller wherein the model includes sub models, the method comprising:
monitoring performance of the controller;
quantifying controller performance degradation as the process changes;
determining whether a selected number of sub models need updating or the entire model dynamics need updating as a function of the quantified controller performance degradation;
if a selected number of sub models need updating, initiating an excitation signal for such sub models to identify new sub models;
if the entire model dynamics need updating, initiate a complete perturbation signal design and trigger identification of entire model; and
incorporating the newly identified model or sub models in the controller.

12. The method of claim 11 wherein faults in devices coupled to the controller are handled separately.

13. The method of claim 11 wherein performance of the controller is monitored while the process is running at an operating point and identification of the entire model is closed loop.

14. The method of claim 11 wherein a regular spearman correlation index between variables, or if there is a strong correlation between variables, a partial correlation analysis between the PEs and the MVs are used as criteria for deciding which of the sub-models have changed.

15. The method of claim 11 wherein the dynamic model represents a dynamic relationship between controlled variables that are measured and regulated, and manipulated variables that are updated by the APC controller.

16. The method of claim 11 wherein the model is modified while the APC controller is active.

17. The method of claim 16 wherein incorporating the newly identified model involves an exponential transition from the current model to the new model.

18. A method of modifying a dynamic model of a process in a plant for an advanced process control controller wherein the model includes sub models, the method comprising:
determining whether a selected number of sub models need updating or the entire model dynamics need updating;
if a selected number of sub models need updating, initiating an excitation signal for such sub models to identify new sub models;
if the entire model dynamics need updating, initiate a complete perturbation signal and trigger identification of entire model; and
incorporating the newly identified model or sub models in the controller.

19. The method of claim 18 wherein:
performance of the controller is monitored while the process is running at an operating point and identification of the entire model is closed loop;
a regular spearman correlation index between variables, or if there is a strong correlation between variables, a partial correlation analysis between the PEs and the MVs are used as criteria for deciding which of the sub-models have changed;
the dynamic model represents a dynamic relationship between controlled variables that are measured and regulated, and manipulated variables that are updated by the APC controller;
the model is modified while the APC controller is active; and
incorporating the newly identified model involves an exponential transition from the current model to the new model.

20. An advanced process control controller utilizing a dynamic model of a process in a plant wherein the model includes sub models for components, the controller comprising:
means for determining whether a selected number of sub models need updating or the entire model dynamics need updating;
means for initiating an excitation signal for such sub models to identify new sub models if a selected number of sub models need updating;
means for initiating a complete perturbation signal and trigger exhaustive closed-loop identification of entire model if the entire model dynamics need updating; and
means for incorporating the newly identified model or sub models in the controller.
